(19) United States
(12) Patent Application Publication
(10) Pub. No.: US 2015/0146254 A1
(43) Pub. Date: May 28, 2015

(54) Image Processing Apparatus and Image Processing Method That Ensures Effective Search

(71) Applicant: Kyocera Document Solutions Inc., Osaka (JP)

(72) Inventor: Hironori Hayashi, Osaka (JP)

(21) Appl. No.: 14/555,683

(22) Filed: Nov. 27, 2014

(30) Foreign Application Priority Data
Nov. 27, 2013 (JP) 2013-245064

(51) Int. Cl. G06K 15/02; G06K 15/00

(52) U.S. Cl. CPC G06K 15/1889; G06K 15/1885; G06K 15/005
USPC 358/1.15

(57) ABSTRACT

An image processing apparatus includes an image processing unit, a text information accepting unit, a stamp processing unit, and an image data editing unit. The image processing unit reads image data on an original document. The text information accepting unit accepts an input of text information from a user after reading the image data. The stamp processing unit creates a stamp image corresponding to the input text information, the stamp processing unit performing an optical character recognition process on the created stamp image to convert text information of the stamp image into text data where a character string is able to be searched. The stamp processing unit adds the stamp image to the image data. The image data editing unit edits a plurality of items of image data including the image data where the stamp image is added as an item of image data.

### INCORPORATION BY REFERENCE

This application is based upon, and claims the benefit of priority from, corresponding Japanese Patent Application No. 2013-245064 filed in the Japan Patent Office on Nov. 27, 2013, the entire contents of which are incorporated herein by reference.

### BACKGROUND

Unless otherwise indicated herein, the description in this section is not prior art to the claims in this application and is not admitted to be prior art by inclusion in this section.

There are various techniques relating to reading image data by an image forming apparatus that reads image data from an original document.

For example, there is a digital color image forming apparatus that includes an image reading unit and an extracting unit. The image reading unit reads an original document by scanning to a main-scanning direction and a sub-scanning direction, and outputs color image data for respective pixels. The extracting unit extracts a region, where a color of the color image data of the original document read by the image reading unit is the color to be set, as a background color region. The digital color image forming apparatus includes a character image data forming unit, an image data combination unit, and an image forming unit. The character image data forming unit forms characters of the predetermined color numeral or text. The image data combination unit combines character image data, which is formed by the character image data forming unit, with the background color region, which is extracted by the extracting unit, of the color image data read by the image reading unit. The image forming unit forms a color image corresponding to image data combined by the image data combination unit. This, for example, assuming that the color to be set is white (the color of the region without image information), causes the character image data to be combined with only the background color region. Accordingly, there is no overlapping of the original document information and the character image data, and then the deciphering of the original document information is ensured.

There is also an image input/output apparatus that visibly outputs an image read from the original document. This image input/output apparatus includes an extracting unit, a comparison unit, a recognizing unit, and an executing unit. The extracting unit extracts image information, which is added preliminarily to this original document, from the original document. The comparison unit compares the extracted image information and the preliminarily registered image information. The recognizing unit detects the predetermined operation and process corresponding to the image information based on the comparison result. The executing unit executes the detected operation and process. As a result, preliminarily specified image information is added to the original document, and the image input/output apparatus executes the operation and the process based on the detected result. This can provide the image input/output apparatus that has simple configuration and excellent operation environment.

There is an image processing apparatus that includes a reading unit and a determining unit. The reading unit reads an original document. The determining unit determines whether or not a seal image is included in the image information read by this reading unit. The image processing apparatus includes a processing unit and an image forming unit. The processing unit performs processing to a seal image when this determining unit determines that the image information includes the seal image. The image forming unit performs image forming on a recording medium based on the image information processed by this processing unit. This permits providing an image processing apparatus that can easily determine whether the seal image is an authentic original document or a duplicate by processing the seal image.

### SUMMARY

An image processing apparatus according to one aspect of the disclosure includes an image processing unit, a text information accepting unit, a stamp processing unit, and an image data editing unit. The image processing unit reads image data on an original document. The text information accepting unit accepts an input of text information from a user after reading the image data. The stamp processing unit creates a stamp image corresponding to the input text information, the stamp processing unit performing an optical character recognition process on the created stamp image to convert text information of the stamp image into text data where a character string is able to be searched. The stamp processing unit adds the stamp image to the image data. The image data editing unit edits a plurality of items of image data including the image data where the stamp image is added as an item of image data.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates the overall configuration of an inside of a multi-functional peripheral according to one embodiment of the disclosure.

FIG. 2 illustrates the overall configuration of an operation unit according to the one embodiment.

FIG. 3 illustrates the configuration of control system hardware of the multi-functional peripheral according to the one embodiment.

FIG. 4 illustrates functions of the multi-functional peripheral according to the one embodiment.

FIG. 5 illustrates an execution procedure according to the one embodiment.

FIG. 6A illustrates one example of an initial screen displayed on a touch panel according to the one embodiment.

FIG. 6B illustrates one example of an image reading screen displayed on the touch panel according to the one embodiment.

FIG. 7A illustrates one example of a text information accepting screen displayed on the touch panel according to the one embodiment.

FIG. 7B illustrates examples of image data and a stamp image according to the one embodiment.

FIG. 8A illustrates an example of image data added to the stamp image according to the one embodiment.

FIG. 8B illustrates an example of image data added to the stamp image according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

An image processing apparatus according to one embodiment of the disclosure will be described below with reference to the attached drawings, for ease of understanding the disclosure. Please note that the following embodiments are merely exemplary embodiments according to the disclosure and not intended to limit the technical scope of the disclosure. The alphabets S attached before numerals in the flowchart mean steps.

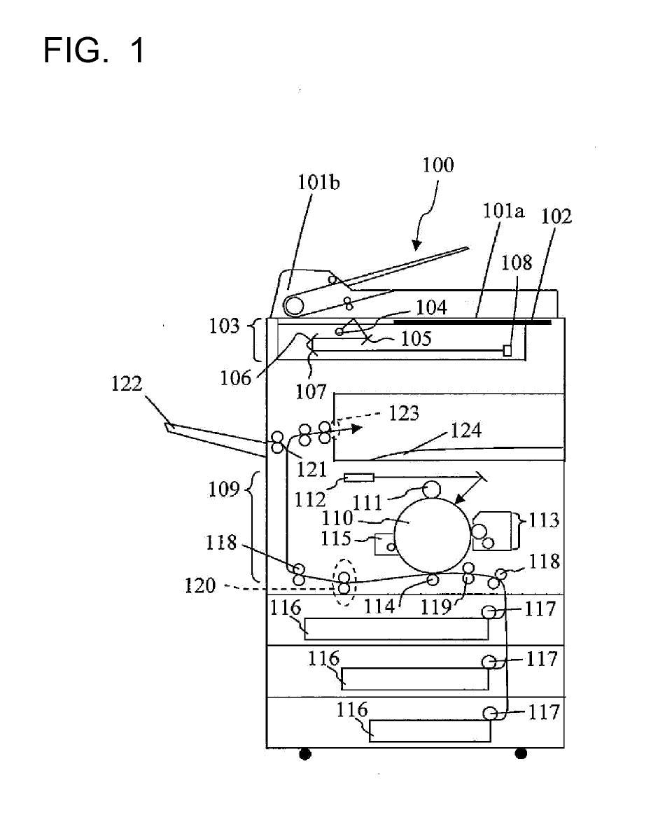

The image processing apparatus according to the embodiment of the disclosure is an image forming apparatus that includes, for example, an image reading unit and an image forming unit. A description will be given of the image forming apparatus below. FIG. 1 schematically illustrates an outline of the image forming apparatus according to one embodiment of the disclosure. However, the details of respective units that do not relate to the disclosure directly are omitted.

The image forming apparatus of the disclosure corresponds to, for example, a stand-alone printer and scanner, or a multi-functional peripheral including a printer, a copying machine, a scanner, a facsimile, and a similar peripheral. The image forming apparatus includes the copying function, the scanner function, the facsimile function, the printer function, and a similar function.

A description will be briefly given about the operation of a multi-functional peripheral 100 (MFP), when, for example, the copying function is used.

First, when a user uses the multi-functional peripheral 100, the user places an original document on a platen 101a, which is arranged in the top surface of a housing portion, or a placement table 101b, which is arranged in an automatic document feeding unit. Subsequently, the user uses an operation unit 102 (operation panel), which is arranged near the platen 101a, to input the setting condition relating to image formation from the operation screen of this operation unit 102. Then, pressing a start key, which is arranged in the operation unit 102, by the user causes the multi-functional peripheral 100 to start image formation (printing process).

Next, in an image reading unit 103, the light irradiated from a light source 104 is reflected to the original document placed on the platen 101a. The reflected light is guided to an imaging device 108 by mirrors 105, 106, and 107. The guided light is photoelectrically converted by the imaging device 108, and then, the image data corresponding to the original document is created.

A part that forms a toner image based on the image data is an image forming unit 109. The image forming unit 109 includes a photoreceptor drum 110. The photoreceptor drum 110 rotates at a constant speed in a predetermined direction. In the peripheral area of the photoreceptor drum 110, a charger 111, an exposure unit 112, a developing unit 113, a transfer unit 114, a cleaning unit 115, and a similar unit are arranged in this order from upstream of the rotation direction.

The charger 111 uniformly charges the surface of the photoreceptor drum 110. The exposure unit 112 irradiates a laser beam to the surface of the charged photoreceptor drum 110 based on the image data to form an electrostatic latent image. The developing unit 113 attaches toner to the formed electrostatic latent image to form a toner image. The formed toner image is transferred to a recording medium (such as a paper sheet and a sheet) by the transfer unit 114. The cleaning unit 115 removes extra toner remaining on the surface of the photoreceptor drum 110. The rotation of the photoreceptor drum 110 executes the set of processes.

The sheet is conveyed from a plurality of sheet feed cassettes 116 included in the multi-functional peripheral 100. When being conveyed, the sheet is drawn from any one of the sheet feed cassettes 116 to a conveyance path by a pickup roller 117. Each of the sheet feed cassettes 116 houses respectively different kind of paper sheets. Each of the sheet feed cassettes 116 feeds sheets based on the setting condition for image formation.

The sheet drawn to the conveyance path is conveyed to between the photoreceptor drum 110 and the transfer unit 114 by a conveyance roller 118 and a registration roller 119. On the conveyed sheet, the toner image is transferred by the transfer unit 114. The transferred sheet is conveyed to a fixing unit 120.

The sheet on which the toner image is transferred passes through between a heating roller and a pressure roller, which are included in the fixing unit 120. Then, heat and pressure is applied to the toner image, and a visible image is fixed on the sheet. The heat amount of the heating roller is set appropriately corresponding to the kind of the paper to fix the visible image appropriately. Thus, the visible image is fixed on the sheet, terminating the image formation. This sheet is guided to a path switching unit 121 by the conveyance roller 118.

The path switching unit 121, corresponding to an instruction to switch by the multi-functional peripheral 100, guides the sheet to a sheet discharge tray 122, which is located on the side face of the scanner housing portion. Alternatively, the path switching unit 121 guides the sheet to an in-barrel tray 124, which is located in the barrel of the scanner housing portion, via a sheet discharge exit 123. The sheet is loaded and housed in the sheet discharge tray 122 or the in-barrel tray 124. The procedure causes the scanner housing portion of the multi-functional peripheral 100 to provide the copying function to the user.

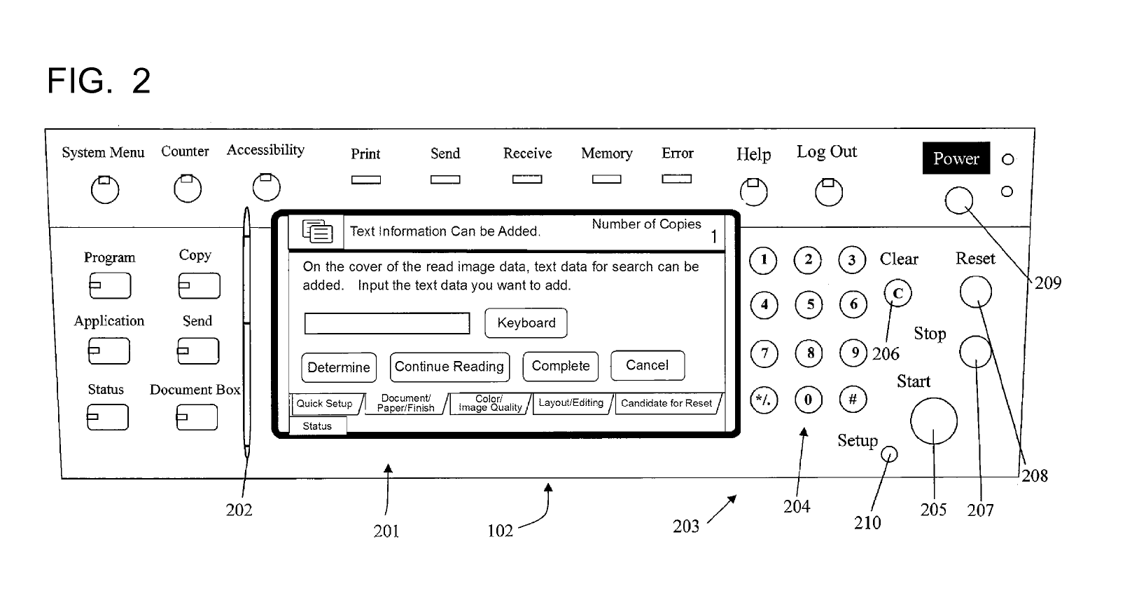

Next, FIG. 2 illustrates the overall configuration of the operation unit according to the embodiment of the disclosure. The user uses the operation unit 102 to input the setting condition for the above-described image formation, or to confirm the setting condition that is input. To input the setting condition, a touch panel 201 (operation panel), a stylus pen 202, and an operation key 203, which are included in the operation unit 102, are used.

The touch panel 201 has both a function to input a setting condition and a function to display this setting condition. That is, pressing a key within the screen displayed on the touch panel 201 causes the setting condition corresponding to this pressed key to be input.

On the back-side of the touch panel 201, a display unit (not illustrated) such as a Liquid Crystal Display (LCD) is located. This display unit displays an operation screen such as the initial screen. Near the touch panel 201, the stylus pen 202 is located. Touching the tip of the stylus pen 202 to the touch panel 201 by the user causes the sensor located below the touch panel 201 to detect where is touched.

Further, near the touch panel 201, the predetermined number of operation keys 203 are located. The predetermined number of operation keys 203 include, for example, a numeric keypad 204, a start key 205, a clear key 206, a stop key 207, a reset key 208, and a power key 209.

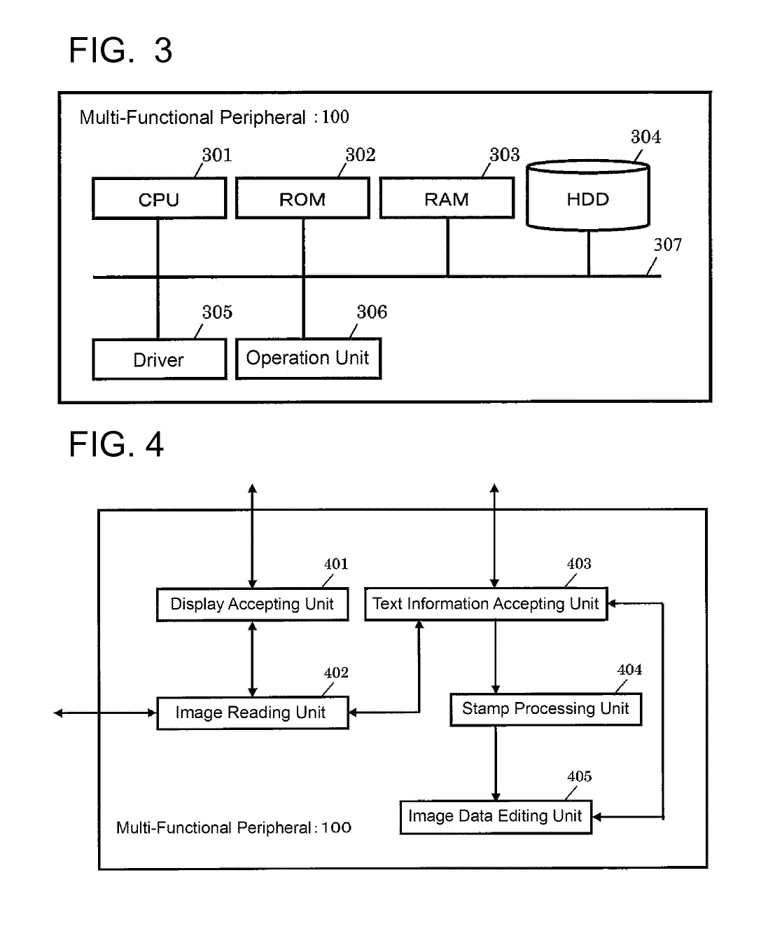

Next, with reference to FIG. 3, the configuration of the control system hardware of the multi-functional peripheral 100 will be described. FIG. 3 illustrates the configuration of the control system hardware of the multi-functional peripheral 100 according to the disclosure. However, the details of respective units that do not relate to the disclosure directly are omitted.

A control circuit of the multi-functional peripheral 100 includes a Central Processing Unit (CPU) 301, a Read Only Memory (ROM) 302, a Random Access Memory (RAM) 303, a Hard Disk Drive (HDD) 304, a driver 305 corresponding to each driving unit, and an operation unit 306 (102), which are connected via an internal bus 307.

The CPU 301 uses, for example, the RAM 303 as a work area. The CPU 301 executes the program stored in a non-temporary storage medium, such as the ROM 302 and the HDD 304. Based on this execution result, the CPU 301 transmits and receives data and a command from the driver 305 and the operation unit 306, a signal and an instruction corresponding to a key, and similar data, so as to control operations of each driving unit illustrated in FIG. 1.

The execution of the program by the CPU 301 ensures the execution of the respective units, which are described below (see FIG. 4) other than the driving unit. The ROM 302, the HDD 304, or a similar medium stores the program and data to ensure the respective units, which are described below.

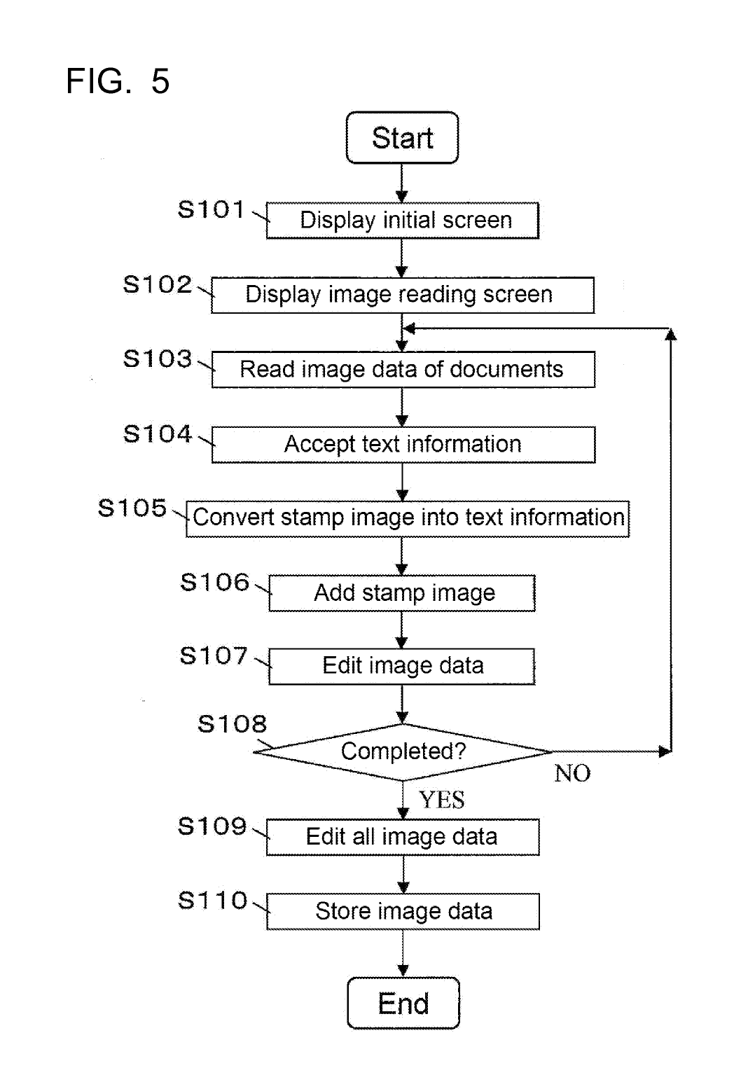

Next, with reference to FIG. 4 and FIG. 5, a description will be given of the configuration and the execution procedure according to the embodiment of the disclosure. FIG. 4 illustrates the functions of the multi-functional peripheral according to the disclosure. FIG. 5 illustrates the execution procedure according to the disclosure.

First, the user turns on the power supply of the multi-functional peripheral 100 and inputs the own authentication information (such as a user ID “A” and the password “aaa”). Then, a display accepting unit 401 of the multi-functional peripheral 100 authenticates the user based on this authentication information and the authentication comparison information, which is preliminarily stored in the predetermined memory. Then, when the input authentication information is included in the authentication comparison information, the display accepting unit 401 displays the initial screen (operation screen) on the touch panel 201 (see FIG. 5 : S101).

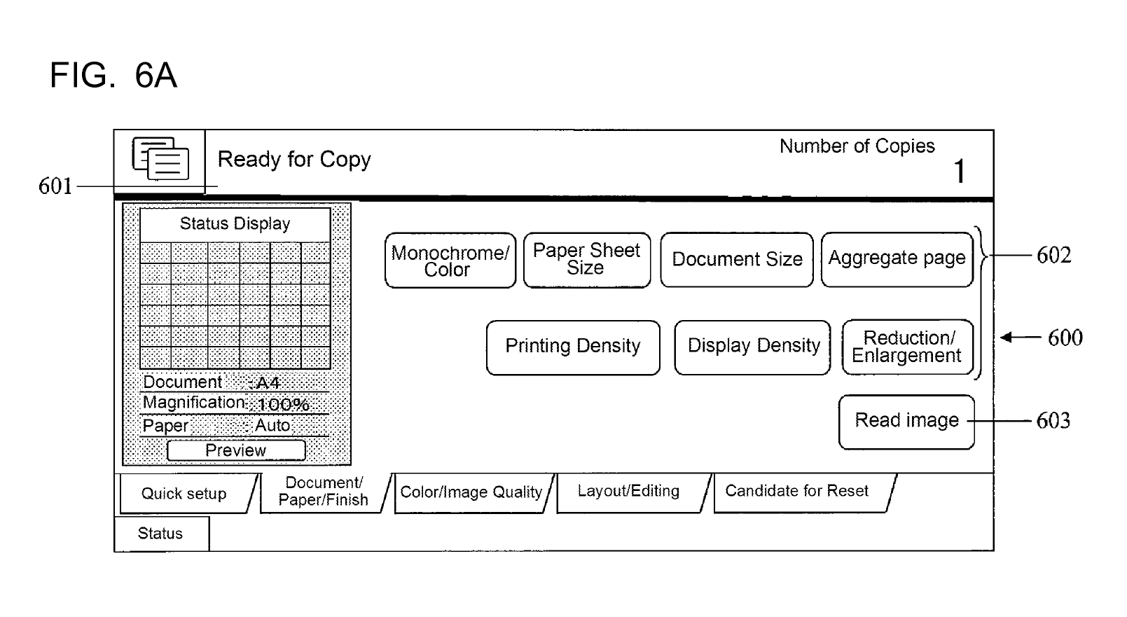

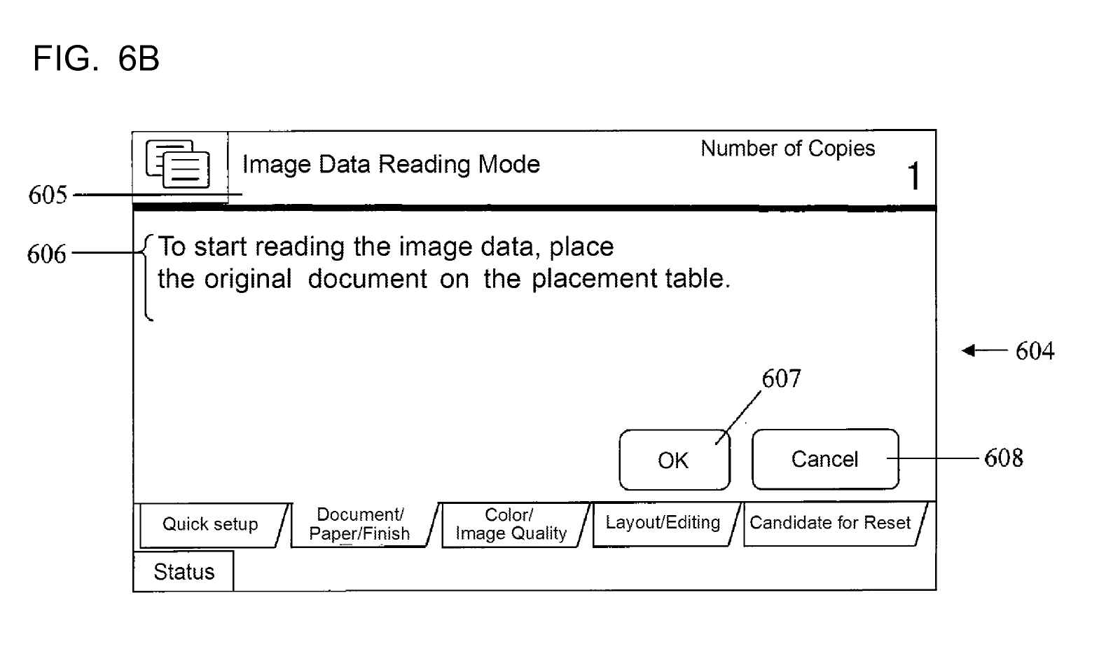

On an initial screen 600, as illustrated in FIG. 6A, a predetermined message “Ready for Copy” 601 is displayed. Additionally, a functional item key 602 and an image reading mode key 603 are displayed as pressing is possible. The functional item key 602 is to input the setting condition for the copying function or a similar function. The image reading mode key 603 is to read an image in the original document. Here, the image reading mode key 603 includes a mode that the predetermined text information can be added to this image data after an image in the original document is read as image data.

For example, as the user attempts to read image data in the bundle of the respective original documents so as to identify each of the bundles of documents (for example, three bundles), the user presses the image reading mode key 603. Then, the display accepting unit 401 accepts the pressing of this image reading mode key 603, and switches the screen on the touch panel 201 from the initial screen to the image reading screen for display (see FIG. 5: S102).

On an image reading screen 604, as illustrated in FIG. 6B, a predetermined message “Image Data Reading Mode” 605 and an instruction “To start reading the image data, place the original document on the placement table.” 606 are displayed. In association with this, an OK key 607 and a cancel key 608 are displayed as pressing is possible.

While watching the image reading screen 604, the user places the one bundle of documents on the placement table 101b of an automatic document feeding unit, and presses the OK key 607. Then, the display accepting unit 401 accepts the pressing of this OK key 607 and notifies the pressing of an image reading unit 402. This image reading unit 402, which receives this notification, conveys the original document one by one from the bundle of documents placed on the placement table 101b to the image reading unit 103, reads image data of the original document, and reads a plurality of items of image data corresponding to the bundle of documents (see FIG. 5: S103). Here, the read image data is formatted in, for example, JPEG format.

After having completed the reading of a plurality of items of image data corresponding to the original document of the bundle of documents, the image reading unit 402 notifies the completion of a text information accepting unit 403. Then, the text information accepting unit 403, which receives this notification, displays a text information accepting screen on the touch panel 201 (see FIG. 5: S104).

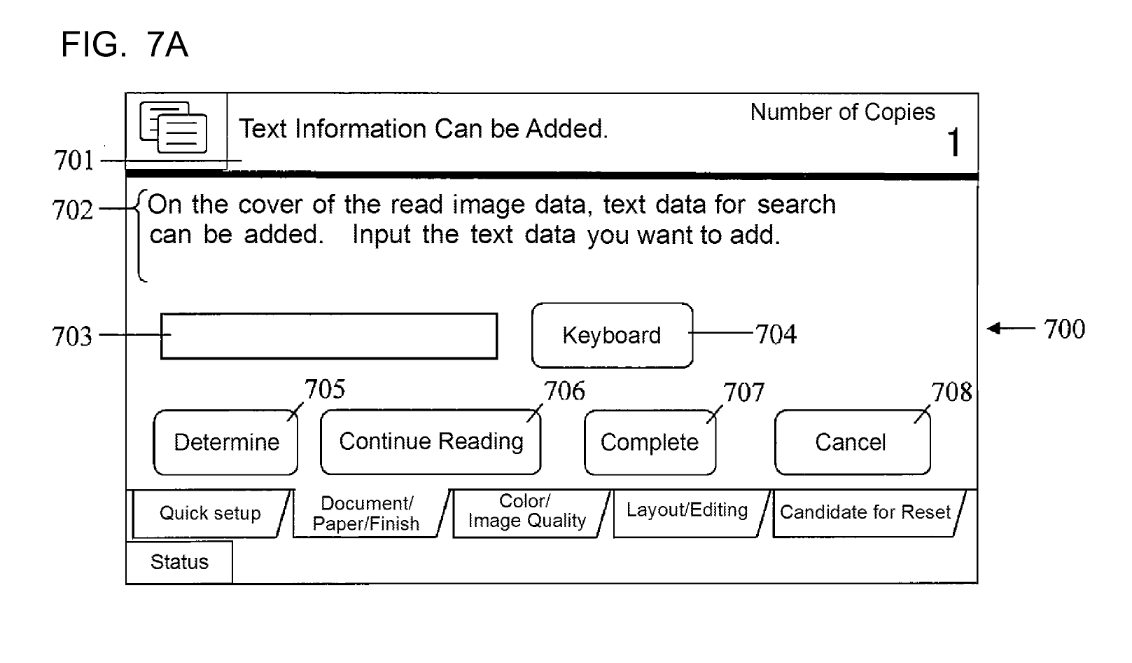

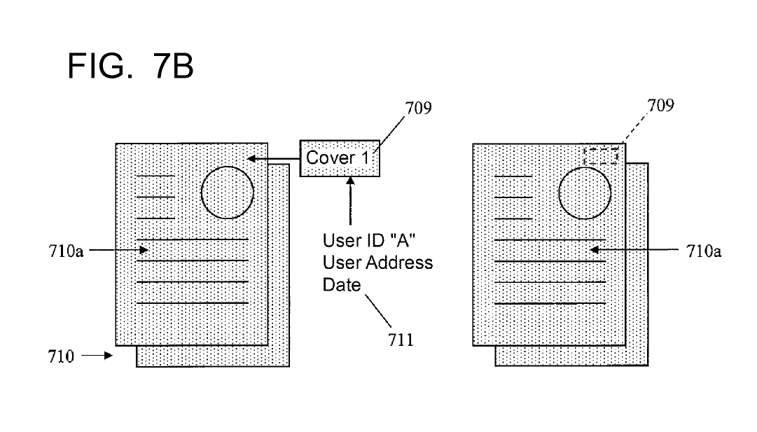

A text information accepting screen 700, as illustrated in FIG. 7A, displays a predetermined message “Text Information Can be Added.” 701, an instruction “On the cover of the read image data, text data for search can be added. Input the text data you want to add.” 702, and an input field 703 to accept the text information. In association with this, the text information accepting screen 700 displays a keyboard key 704, a determination key 705, a reading continuation key 706, a complete key 707, and a cancel key 708 in a state that these keys are possible to be pressed. The keyboard key 704 is to input predetermined text information to the input field 703. The determination key 705 is to determine the input of the text information. The reading continuation key 706 is to carry on reading of image data. The complete key 707 is to complete the operation. The cancel key 708 is to cancel the operation.

The user uses the keyboard key 704 to input the text information “Cover 1” in the input field 703 while watching the text information accepting screen 700. Pressing the determination key 705 with the input, the text information accepting unit 403 accepts the input of this text information “Cover 1” and notifies the input to a stamp processing unit 404. The stamp processing unit 404, which receives this notification, creates a stamp image corresponding to the input text information. The stamp processing unit 404 performs the optical character recognition (OCR) process to this created stamp image and converts the text information of this stamp image into the text data that is possible to be searched by the character string (FIG. 5: S105).

Any method may be employed for the stamp processing unit 404 to create the stamp image and convert the text information of this stamp image into the text data. For example, the processes can be performed as follows.

That is, as illustrated in FIG. 7B, first, the stamp processing unit 404 uses the stamp function included in the multi-functional peripheral 100 preliminarily to create a stamp image 709 of the input text information “Cover 1.” Here, the stamp image 709 is, for example, square-shaped image data that has the text information “Cover 1” as the center. The format of this image data is, for example, a JPEG format, which is the format of the image data of the original document.

Next, the stamp processing unit 404 refers to first read cover image data 710a, that is, cover image data 710a that corresponds to the cover of the original document, among the plurality items of image data 710 that is read earlier, to identify the background color of the image of the cover image data 710a. Here, assume that the background color of the image of the cover image data 710a is gray. Then, the stamp processing unit 404 makes the background color of the stamp image 709 the same color as the identified background color of the image of the cover image data 710a. This makes impossible to be visible at a glance where the cover image data 710a is added when the stamp image 709 is added. Then, the user can confirm the content of the cover image data 710a without disturbed by the stamp image 709.

Then, the stamp processing unit 404 performs the optical character recognition process to the stamp image 709, and converts the text information “Cover 1” of this stamp image into the text data “Cover 1.” For example, when using the search function preliminarily included in the multi-functional peripheral 100 or a computer terminal device, this search function may usually search based on the text data (the character string). In this case, the user can use the search function to search the cover image data 710a by making the text information of the stamp image 709 the text data.

The stamp processing unit 404 makes the color of the text data the same color as the background color of the image of the identified cover image data 710a. This causes the existence of the stamp image 709 to have poorer visibility in the cover image data 710a, and ensures better visibility of only the content of the image data.

The stamp processing unit 404 stores user information 711 associating with the stamp image 709. The user information 711 is the information of the user who added the text information “Cover 1”, that is, the user who is authenticated currently. The user information includes, for example, the user ID “A”, the e-mail address of the user that is obtainable based on this user ID “A”, and the date that the user adds the stamp image 709. This ensures identifying the user who added the stamp image 709 by the user information 711.

Then, the stamp processing unit 404 adds the stamp image 709 to the cover image data 710a (FIG. 5: S106). Here, any method may be employed for the stamp processing unit 404 to add the stamp image 709 by any method. For example, as illustrated in FIG. 7B, the stamp processing unit 404 may add the stamp image 709 to the part near the peripheral end portion of the cover image data 710a (such as near the upper right end portion). The stamp image 709 itself is the same color as the background color of the image of the cover image data 710a, and nothing is viewable at a glance. When adding the stamp image 709 to the cover image data 710a, the stamp processing unit 404 stores the user information 711 as the data information associating with the stamp image 709 without indicating the user information 711 on the stamp image 709.

After having completed the addition of the stamp image, the stamp processing unit 404 notifies the completion to an image data editing unit 405. The image data editing unit 405, which receives this notification, edits the plurality items of image data 710 including the image data (the cover image data 710a) on which the stamp image 709 is added, as an item of image data (FIG. 5: S107).

Any method may be employed for the image data editing unit 405 to edit the plurality items of image data 710 as an item of image data by any method. For example, the process can be performed as follows.

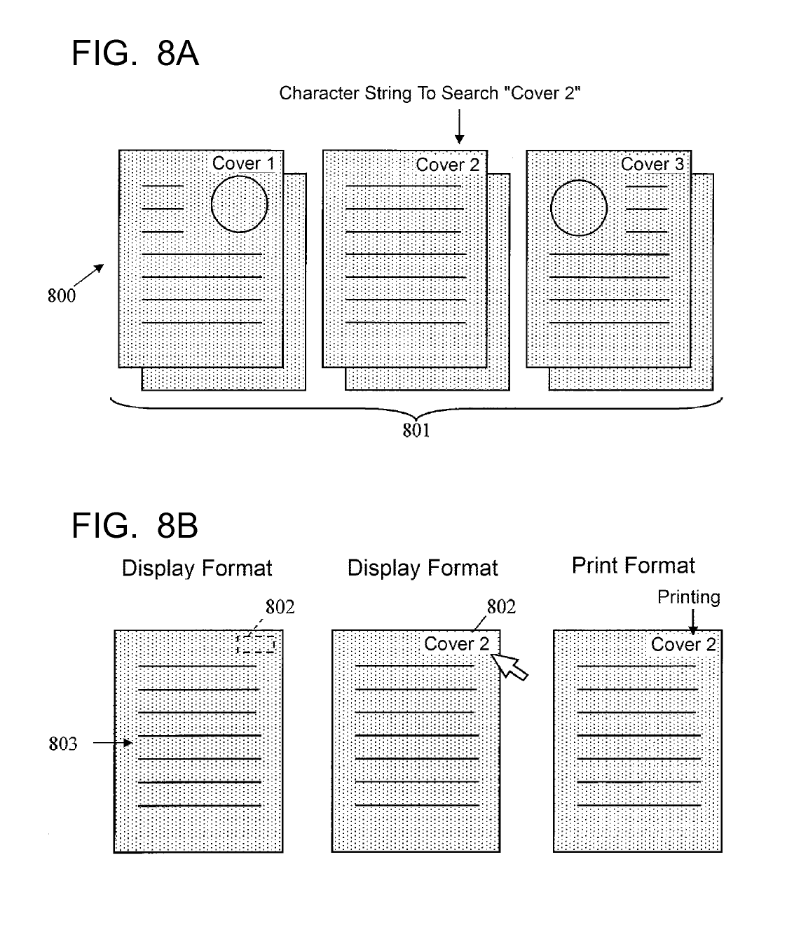

That is, not only the cover image data 710a but also other image data 710, the format of image data is JPEG format. Then, the image data editing unit 405 converts the format of the plurality items of image data 710 corresponding to the original document of the bundle of documents with the cover image data 710a as the first page. The image data editing unit 405 converts the format of a plurality of items of image data 710 from JEPG format to PDF format. Then, as illustrated in FIG. 8A, the image data editing unit 405 edits the plurality items of image data 710 including the cover image data 710a into an item of image data 800. This ensures the user to obtain the image of predetermined bundle of documents as the an item of image data 800.

Here, there are two more bundles of documents after editing image data of one bundle of the original document. The user places the next bundle of documents on the placement table 101b and presses the reading continuation key 706 (FIG. 5: NO at S108), while watching the text information accepting screen 700 (FIG. 5: S108). The text information accepting unit 403 accepts pressing of this reading continuation key 706, notifies the pressing to the image reading unit 402, and returns to S103. The image reading unit 402 reads a plurality of items of image data corresponding to the bundle of documents (FIG. 5: S103).

The text information accepting unit 403 accepts inputting of the predetermined text information by the user via the text information accepting screen 700 (FIG. 5: S103). The stamp processing unit 404 creates the stamp image corresponding to the input text information. Then, the stamp processing unit 404 performs the optical character recognition process to this created stamp image, converts the text information of this stamp image into the text data (FIG. 5: S105), and adds this stamp image to the image data (FIG. 5: S106). Then, the image data editing unit 405 edits a plurality of items of image data including the image data on which the stamp image 709 is added, as an item of image data (FIG. 5: S106).

Assume that by repeating a series of such processes, for example, the stamp image of the text information “Cover 1” is added on the cover image data of the image data of the first bundle of documents, the stamp image of the text information “Cover 2” is added on the cover image data of the image data of the next bundle of documents, and the stamp image of the text information “Cover 3” is added on the cover image data of the image data of the last bundle of documents.

Then, the user presses the complete key 707 (FIG. 5: YES at S108), while watching the text information accepting screen 700 (FIG. 5: S108). The text information accepting unit 403 accepts pressing of this reading continuation key 706 and notifies the pressing to the image data editing unit 405. The image data editing unit 405, which receives this notification, unifies a plurality of JPEG format image data that are edited up to the present, and edits the image data as one JPEG format image data (FIG. 5: S109).

For example, the image data editing unit 405, as illustrated in FIG. 8A, edits the JPEG format image data of three bundles of documents into one JPEG format image data 801. This ensures the user to obtain the image data of a plurality of bundle of documents as an item of image data 801.

Then, the image data editing unit 405 causes the predetermined memory in the multi-functional peripheral 100 to store the one JPEG format image data 801 that is edited (FIG. 5: S110). The user can use a portable storage member such as a USB memory to store the JPEG format image data 801 that is stored in the memory, and carry the JPEG format image data 801. The user can use a transmitting function (SEND function) of the multi-functional peripheral 100 to transmit the JPEG format image data 801 to the own computer terminal device. This ensures the user to display and confirm the JPEG format image data 801 on the own computer terminal device.

Here, as described above, the text information of the stamp image is added as the text data on image data of a plurality of the bundle of documents included in the one JPEG format image data 801. Then, assume that, for example, the user causes the JPEG format image data 801 to be displayed and uses the search function to execute searching by inputting text data as a character string to search such as “Cover 2.” In this case, the image data on which the text data is added can be searched easily because the text data of the character string corresponding to the character string to search is included in the JPEG format image data 801. That is, conventionally, the user cannot add the text data or similar data to image data. Accordingly, for example, to search specific image data among the JPEG format image data constituted of a plurality of items of image data, the user needs to scroll a plurality of items of image data (turn pages) purposely for searching. It takes time and effort. The disclosure processes image data by combining the stamp function and the optical character recognition function of the multi-functional peripheral 100. This makes searching specific image data easily among a plurality of items of image data possible.

The display format and the print (image formation) format of the one JPEG format image data are set as follows.

That is, as illustrated in FIG. 8B, the background color of a stamp image 802 and the color of the text data of the text information are the same color as the background color of image of image data 803. Accordingly, when one JPEG format image data is displayed on, for example, the touch panel 201 of the multi-functional peripheral 100 or the liquid crystal display of the computer terminal device, these stamp image 802 and text data of the text information are not visible at a glance. This ensures the user to confirm the content of the image data 803 without disturbed by the stamp image 802.

As the text data of the stamp image 802 exists, for example, as illustrated in FIG. 8B, dragging the part of the stamp image 802 by a pointer or a similar tool causes the character of the text data of this stamp image 802 to be displayed inverted. This ensures the user to confirm the existence of this text data.

Here, for example, the configuration of the display accepting unit 401 may be configured such that the display accepting unit 401 uses the user information stored associating with the stamp image 802 to change the display format corresponding to the user. For example, assume that the display accepting unit 401, which displays the image data 803, verifies the user information (user ID) of the currently authenticated user and the user information (user ID) associated with the stamp image 802 of this image data 803, and found that they are not identical. In this case, the display accepting unit 401 determines that the user who confirms this image data 803 is a user who does not add the stamp image 802 (the third person), and changes the color of the stamp image 802 to display this stamp image 802 in visible. For example, the display accepting unit 401 changes the color of the outside frame of the stamp image 802 to black, and changes the color of the text data to black. This ensures the user as the third person to confirm the content of the stamp image 802. On the other hand, when both user information (user ID) are identical, the display accepting unit 401 determines that the user who confirms this image data 803 is a user who added the stamp image 802. The display accepting unit 401 does not change the color of the stamp image 802. This ensures the user who added the stamp image 802 to save the unnecessary process without purposely visualizing the stamp image 802 because the user knows the existence of this stamp image 802 originally.

Above-described aspects may be inverted. For example, the following configuration may be acceptable. When both user information (user ID) is not identical, the display accepting unit 401 does not change the color of the stamp image 802. When both user information (user ID) is identical, the display accepting unit 401 changes the color of the stamp image 802 to display this stamp image 802 in visible.

Additionally, the following configuration may be acceptable. For example, in the image formation of the image data 803 that includes the stamp image 802, the image forming unit may use the user information that is stored associating with the stamp image 802 to change the print format corresponding to the user. For example, assume that the image forming unit verifies the user information (user ID) of the currently authenticated user and the user information (user ID) that is associated with the stamp image 802 of this image data 803, and they are not identical. In this case, the image forming unit performs the image formation of the stamp image 802 and the text data with the image data 803. This ensures the reduction of the replication by the user as the third person because the stamp image 802 and the text data that are not visible until then are suddenly printed.

Here, for example, the following configuration may be acceptable. When the user as the third person performs the image formation based on the image data 803, the image forming unit notifies the fact to a transmitting unit. The transmitting unit, which receives this notification, notifies that the image formation by the third person has been executed, to the user of this user information based on the user information (the e-mail address of the user) associated with the stamp image 802 of the image data 803. This ensures the user who added the stamp image 802 to know the image formation by the third person and to take countermeasures against the replication or a similar failure.

On the other hand, when both user information are identical, the image forming unit performs the image formation of only the image data 803, and does not perform the image formation of the stamp image 802 and the text data. This ensures distinguishing the image formation by the user who added the stamp image 802 from the image formation by the third person (printed matter) because the stamp image 802 is not printed.

The above-described display accepting unit 401, image forming unit, and transmitting unit are assumed as, for example, the units included in the multi-functional peripheral 100. However the units may be the units that are included in the computer terminal device.

As described above, the disclosure includes the text information accepting unit 403, the stamp processing unit 404, and the image data editing unit 405. The text information accepting unit 403 reads image data and accepts the input of the text information from the user. The stamp processing unit 404 creates the stamp image corresponding to the input text information and performs the optical character recognition process to this created stamp image. Then, the stamp processing unit 404 converts the text information of this stamp image into the text data on which the character string search can be performed, and adds the stamp image to the image data. The image data editing unit 405 edits a plurality of items of image data including the image data on which the stamp image is added as an item of image data. This ensures searching the read image data efficiently.

With the embodiment of the disclosure, the image data on which the stamp image is added is the cover image data. However, other configurations may be acceptable. For example, the stamp processing unit 404 may be configured to add the stamp image to the image data selected by the user among a plurality of items of image data. This ensures an improved flexibility to the user.

With the embodiment of the disclosure, the position on which the stamp image is added is near the upper right end portion of the cover image data. However, other configurations may be acceptable. For example, the stamp processing unit 404 may have the configuration that adds the stamp image on the position selected by the user. This ensures a flexibility to the user.

With the embodiment of the disclosure, the background color of the stamp image and the color of the text data are the same as the background color of the image of the image data. However, other configurations may be acceptable. For example, the stamp processing unit 404 may make the background color of the stamp image and the color of the text data as colorless (transparent color). The configuration also ensures avoiding being disturbed visually of the stamp image and the text data.

With the embodiment of the disclosure, the multi-functional peripheral 100 is configured to include the respective units. However, the configuration where the programs, which ensure the respective units, are stored in a storage medium and this storage medium is provided may be acceptable. This configuration causes the multi-functional peripheral 100 to read out the program, and the multi-functional peripheral 100 ensures the respective units. In this case, the program itself that is read out from the recording medium provides an action and effect of the disclosure. Furthermore, the configuration can provide the step that the respective units execute as the method for storage in the hard disk.

As described above, the image processing apparatus and the image processing method according to the disclosure are effective to not only a multi-functional peripheral but also a scanner, a copier, a printer, and a similar apparatus. The image processing apparatus and the image processing method according to the disclosure are effective to search read image data efficiently.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An image processing apparatus, comprising:
an image processing unit that reads image data on an original document;
a text information accepting unit that accepts an input of text information from a user after reading the image data;
a stamp processing unit that creates a stamp image corresponding to the input text information, the stamp processing unit performing an optical character recognition process on the created stamp image to convert text information of the stamp image into text data where a character string is able to be searched, the stamp processing unit adding the stamp image to the image data; and
an image data editing unit that edits a plurality of items of image data including the image data where the stamp image is added as an item of image data.

2. The image processing apparatus according to claim 1, wherein the stamp processing unit adds the stamp image at a position selected by a user in an image of the image data selected by the user.

3. The image processing apparatus according to claim 1, wherein the stamp processing unit sets a background color of the stamp image and a color of text data to the same color as the background color of an image of the image data.

4. The image processing apparatus according to claim 1, wherein:
the stamp processing unit associates the stamp image with user information of the user who adds the text information, the stamp processing unit causing the stamp image and the user information to be stored; and
the image processing apparatus further includes a display unit that displays the stamp image according to whether a user uses the user information when the image data is displayed.

5. The image processing apparatus according to claim 1, wherein:
the stamp processing unit associates the stamp image with user information of the user who adds the text information, the stamp processing unit causing the stamp image and the user information to be stored; and
the image processing apparatus further includes an image forming unit that performs image formation on the stamp image according to whether a user uses the user information when image formation is performed based on the image data.

6. The image processing apparatus according to claim 1, wherein:
the stamp processing unit associates the stamp image with the user information of the user who adds the text information, the stamp processing unit causing the stamp image and the user information to be stored; and
the image processing apparatus further includes a transmitting unit that notifies the user of the user information of an image formation being performed using the user information when the image formation is performed based on the image data.

7. An image processing method, comprising:
reading image data on an original document;
accepting an input of text information from a user after reading the image data;
creating a stamp image corresponding to the input text information;
performing an optical character recognition process on the created stamp image to convert text information of the stamp image into text data where a character string is able to be searched;
adding the stamp image to the image data; and
editing a plurality of items of image data including the image data where the stamp image is added as an item of image data.

8. A non-transitory computer-readable recording medium storing an image processing program for controlling an image processing apparatus, the image processing program causing a computer to function as:
an image processing unit that reads image data on an original document;
a text information accepting unit that accepts an input of text information from a user after reading the image data;
a stamp processing unit that creates a stamp image corresponding to the input text information, the stamp processing unit performing an optical character recognition process on the created stamp image to convert text information of the stamp image into text data where a character string is able to be searched, the stamp processing unit adding the stamp image to the image data; and
an image data editing unit that edits a plurality of items of image data including the image data where the stamp image is added as an item of image data.
